(19) United States
(12) Patent Application Publication
(10) Pub. No.: US 2009/0002570 A1
(43) Pub. Date: Jan. 1, 2009

(54) Broadcast Receiving Apparatus and Broadcast Receiving Method

(75) Inventor: Yutaka Oki, Ome-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/146,335

(22) Filed: Jun. 25, 2008

(30) Foreign Application Priority Data
Jun. 29, 2007 (JP) 2007-173278

(51) Int. Cl. H04N 5/455; H04N 5/50

(52) U.S. Cl. 348/726; 348/731; 348/E05.097; 348/E05.113

(57) ABSTRACT

According to one embodiment, in switching of a channel to a digital broadcasting tuner, when the switched channel is selected by any of a plurality of one-segment broadcasting tuners, an output of an one-segment data processing part, which applies demodulation processing and decode processing to an output of the one-segment broadcasting tuner selecting a broadcasting signal of the switched channel, is selected. When a digital data processing part terminates the demodulation processing and the decode processing to the broadcasting signal selected by the digital broadcasting tuner, the output is switched such that an output of the digital data processing part is selected and output.

### CROSS-REFERENCE TO RELATED APPLICATIONS

This application is based upon and claims the benefit of priority from Japanese Patent Application No. 2007-173278, filed Jun. 29, 2007, the entire contents of which are incorporated herein by reference.

### BACKGROUND

1. Field

One embodiment of the invention relates to the improvement of a broadcast receiving apparatus and a broadcast receiving method suitable for reception of, for example, digital television broadcasting and the like.

2. Description of the Related Art

As is generally known, recently, the switchover to digital television broadcasting has progressed. For instance, in Japan, in addition to digital direct broadcasting by satellite (DBS), terrestrial digital broadcasting has commenced.

In digital television broadcasting, the time required for demodulation and decoding of the broadcasting signal is longer than for analog television. Therefore, a receiving apparatus which receives the digital television broadcasting is strongly required to reduce a time, especially from the switching of a channel to the obtaining of video, audio, and so on.

Jpn. Pat. Appln. KOKAI Publication No. 2005-130087 discloses a configuration in which a plurality of tuners receiving the digital broadcasting are provided, and when the digital broadcasting selected by one of the tuners is viewed, a channel having a high possibility of being next selected by a user is predicted based on a past channel transition history of the user, and the predicted channel is selected by another tuner.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 shows one embodiment of the invention and is a front view for explaining an outline of a digital television broadcast receiving apparatus;

FIG. 2 is a block diagram for explaining a signal processing system of the digital television broadcast receiving apparatus in the same embodiment;

FIG. 3 is a block diagram for explaining one example of a switching part of the digital television broadcast receiving apparatus in the same embodiment;

FIG. 4 is a block diagram for explaining one example of a control part of the digital television broadcast receiving apparatus in the same embodiment;

FIG. 5 is a view for explaining a tuner setting list stored in a storage part of the digital television broadcast receiving apparatus in the same embodiment;

FIG. 6 is a flowchart for explaining one example of a channel selection processing operation performed by the digital television broadcast receiving apparatus in the same embodiment;

FIG. 7 is a view for explaining a switching operation timing in a channel selection processing performed by the digital television broadcast receiving apparatus in the same embodiment;

FIG. 8 is a flowchart for explaining a part of an update processing operation of the tuner setting list performed by the digital television broadcast receiving apparatus in the same embodiment;

FIG. 9 is a flowchart for explaining the remaining part of the update processing operation of the tuner setting list performed by the digital television broadcast receiving apparatus in the same embodiment;

FIG. 10 is a view for explaining one example of a program listing screen displayed in the digital television broadcast receiving apparatus in the same embodiment;

FIG. 11 is a view for explaining a state before updating the tuner setting list stored in the digital television broadcast receiving apparatus in the same embodiment;

FIG. 12 is a view for explaining a state after updating the tuner setting list stored in the digital television broadcast receiving apparatus in the same embodiment;

FIG. 13 is a block diagram for explaining a modified example of the digital television broadcast receiving apparatus in the same embodiment;

FIG. 14 is a block diagram for explaining another modified example of the digital television broadcast receiving apparatus in the same embodiment; and

FIG. 15 is a flowchart for explaining one example of the channel selection processing operation performed in still another modified example of the digital television broadcast receiving apparatus of the invention.

### DETAILED DESCRIPTION

Various embodiments according to the invention will be described hereinafter with reference to the accompanying drawings. In general, according to one embodiment of the invention, in switching of a channel to a digital broadcasting tuner, when the switched channel is selected by any of a plurality of one-segment broadcasting tuners, an output of an one-segment data processing part, which applies demodulation processing and decode processing to an output of the one-segment broadcasting tuner selecting a broadcasting signal of the switched channel, is selected. When a digital data processing part terminates the demodulation processing and the decode processing to the broadcasting signal selected by the digital broadcasting tuner, the output is switched such that an output of the digital data processing part is selected and output.

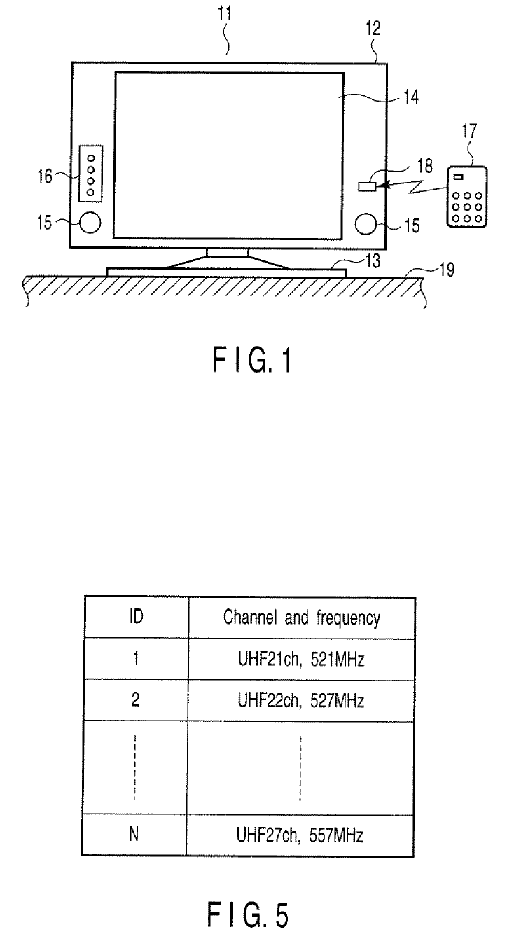

Hereinafter, an embodiment of the invention will be described in detail with reference to the drawings. FIG. 1 is a front view of a digital television broadcast receiving apparatus 11 to be described in this embodiment. The digital television broadcast receiving apparatus 11 is mainly composed of a thin cabinet 12 and a support plate 13 for supporting the cabinet 12.

The cabinet 12 is provided with a flat display panel 14 composed of, for example, a surface-conduction electron-emitter display (SED) and disposed in the front center part thereof. Further, in the cabinet 12, a pair of speakers 15, an operation section 16, a receiving part 18 which receives operation information sent from a wireless remote controller 17, and so on are disposed on the both sides of the flat display panel 14.

The support plate 13 is rotatably connected to the bottom center part of the cabinet 12. The support plate 13 is configured to stably support the cabinet 12 which is in the state of standing when the support plate 13 is placed on a horizontal surface of a predetermined base 19 such as a television table on which a television is placed.

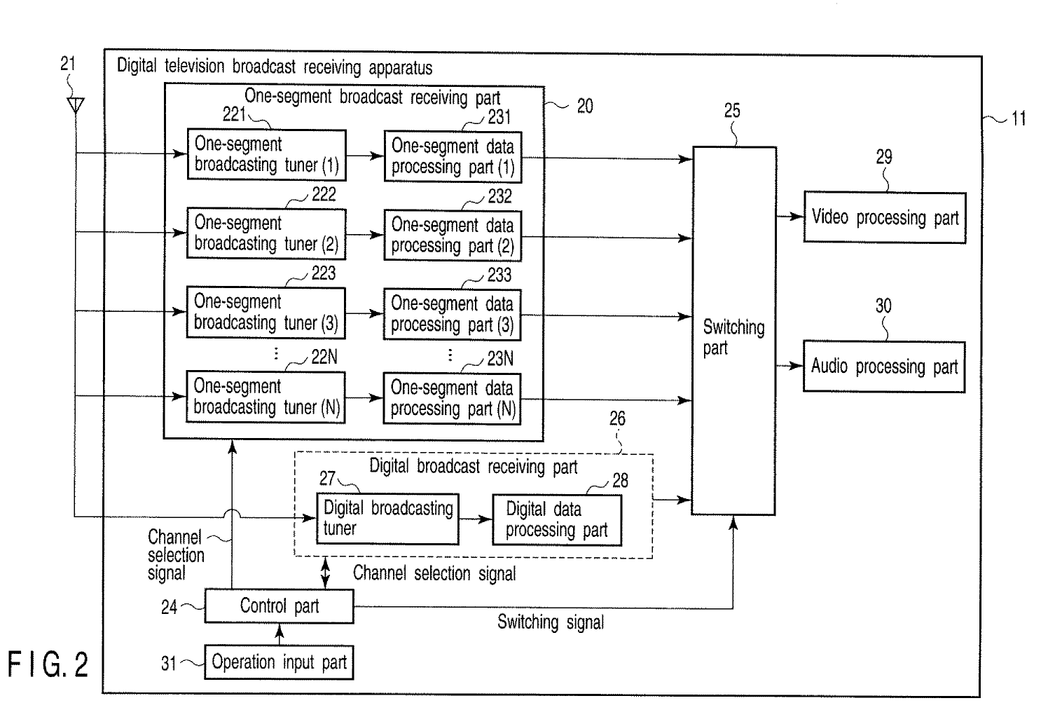

FIG. 2 schematically shows a signal processing system of the digital television broadcast receiving apparatus 11. First, the digital television broadcast receiving apparatus 11 is provided with a one-segment broadcast receiving part 20 which receives one-segment broadcasting which is a service for mobile reception compliant to an Integrated Services Digital Broadcasting for Terrestrial (ISDB-T) system as the technical standard of terrestrial digital broadcasting.

The one-segment broadcast receiving part 20 receives one-segment broadcasting through an antenna 21 to reproduce the broadcasting content. The one-segment broadcast receiving part 20 is composed of a plurality of (N) tuners 221, 222, 223, . . . , and 22N for one-segment broadcasting and one-segment data processing parts 231, 232, 233, . . . , and 23N respectively connected to these one-segment broadcasting tuners 221 to 22N.

The one-segment broadcasting tuners 221 to 22N respectively select a broadcasting signal of a channel, which is instructed by a channel selection signal output from a control part 24, from the one-segment broadcasting received through the antenna 21 to output the selected one-segment broadcasting signal. In this case, the one-segment broadcasting tuners 221 to 22N can respectively select channels different from each other.

The one-segment data processing parts 231 to 23N respectively apply various processings, such as orthogonal frequency division multiplexing (OFDM) demodulation processing and decode processing, to the one-segment broadcasting signal output from the one-segment broadcasting tuners 221 to 22N connected corresponding to the one-segment data processing parts 231 to 23N, thereby generating one-segment broadcasting data realizing reproduction of video and audio to output the one-segment broadcasting data to a switching part 25.

The digital television broadcast receiving apparatus 11 is provided with a digital broadcast receiving part 26 which receives digital broadcasting which uses a plurality of segments such as a 12-segment and is a service for fixed reception. The digital broadcast receiving part 26 receives the digital broadcasting using the plurality of segments through the antenna 21 to reproduce the broadcasting content.

Specifically, the digital broadcast receiving part 26 is composed of a tuner 27 for digital broadcasting and a digital data processing part 28. The digital broadcasting tuner 27 first selects a broadcasting signal of a cannel, which is instructed by a channel selection signal output from the control part 24, from the digital broadcasting received through the antenna 21 to output the selected digital broadcasting signal.

The digital data processing part 28 applies various processings, such as OFDM demodulation processing and decode processing, to the digital broadcasting signal output from the digital broadcasting tuner 27, thereby generating digital broadcasting data realizing reproduction of video and audio to output the digital broadcasting data to the switching part 25. When the digital data processing part 28 terminates the above processing, the digital data processing part 28 outputs a processing termination signal to the control part 24.

The switching part 25 selects one broadcasting data, which is instructed by a switching signal output from the control part 24, from the broadcasting data output from each one-segment data processing part 231 to 23N and the digital data processing part 28 to output a video component and an audio component of the selected broadcasting data to a video processing part 29 and an audio processing part 30.

The video processing part 29 applies a predetermined signal processing for video display on the flat display panel 14 to the input video component of the broadcasting data to display the video component as a video image on the flat display panel 14. The audio processing part 30 applies a predetermined signal processing for audio reproduction by the speaker 15 to the input audio component of the broadcasting data to reproduce the audio component as an audio output by the speaker 15.

The control part 24 controls overall various operations including the above various receiving operations in the digital television broadcast receiving apparatus 11. In this case, the control part 24 receives operation information from an operation input part 31 including the operation part 16, the remote controller 17, and so on, whereby the control part 24 controls each part so as to reflect the operation content to these parts.

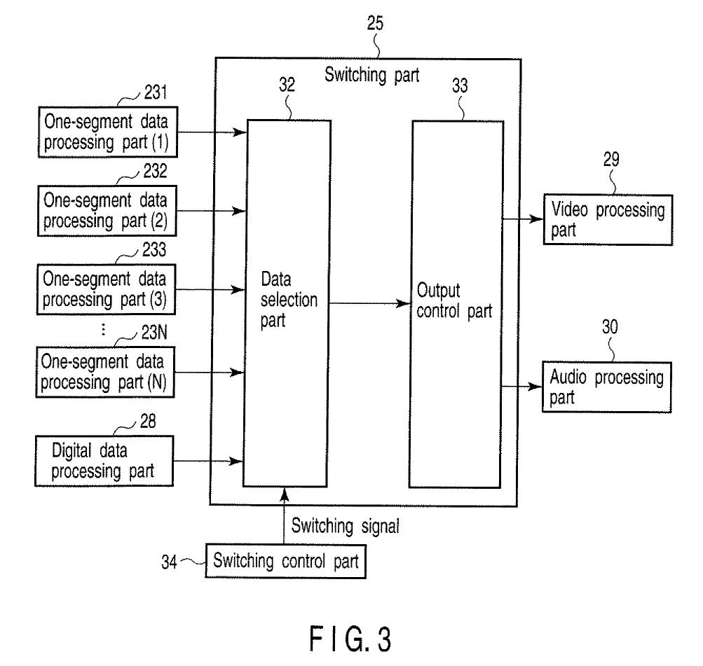

FIG. 3 shows an example of the switching part 25. Specifically, the switching part 25 is provided with a data selection part 32 and an output control part 33. The data selection part 32 selects any one of the broadcasting data respectively output from the one-segment data processing parts 213 to 23N and the digital data processing part 28 to output the selected broadcasting data to the output control part 33. This selection is performed based on a switching signal output from a switching control part 34 provided in the control part 24. Regarding the broadcasting data output from the data selection part 32, the output control part 33 controls to output the video component of the broadcasting data to the video processing part 29, and output the audio component to the audio processing part 30.

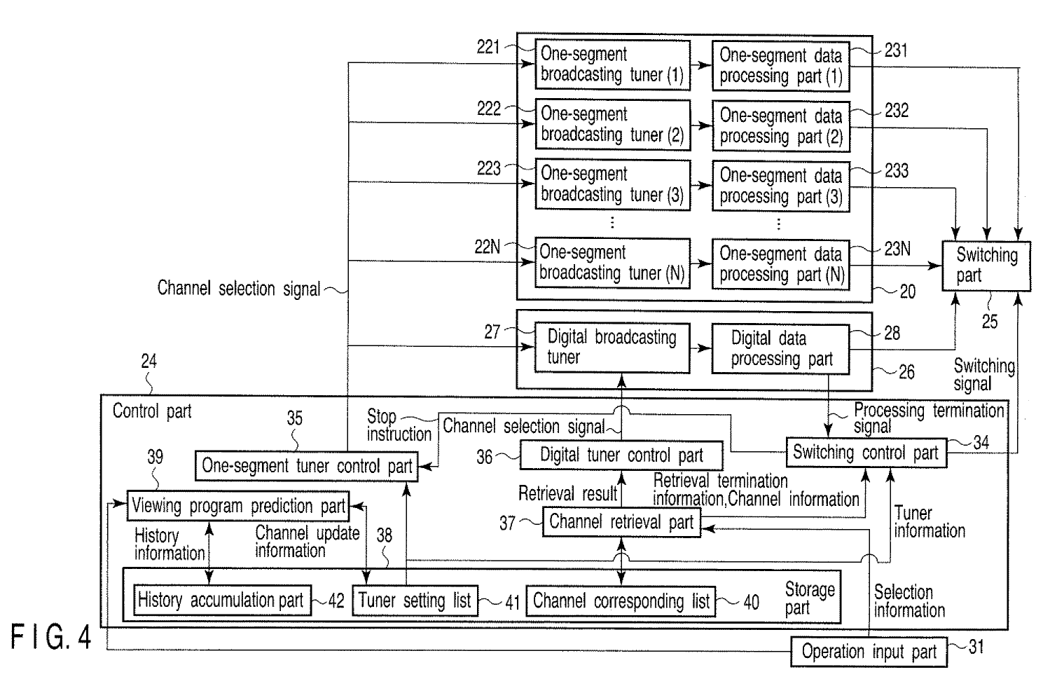

FIG. 4 shows an example of the control part 24. The control part 24 is provided with the switching control part 34, a one-segment tuner control part 35, a digital tuner control part 36, a channel retrieval part 37, a storage part 38, a viewing program prediction part 39, and the like.

The channel retrieval part 37 retrieves a channel of digital broadcasting broadcasted by a broadcasting station which has been designated by a user, on the basis of channel selection information output from the operation input part 31. This retrieval is performed by referring to a channel corresponding list 40 stored in the storage part 38. The channel retrieval part 37 outputs the retrieval result to the digital tuner control part 36 and the one-segment tuner control part 35.

The storage part 38 stores the channel corresponding list 40 and a tuner setting list 41, and at the same time, is provided with a history accumulation part 42 for accumulating a viewing history of users. A channel of digital broadcasting being broadcasted by each broadcasting station and the frequency of the channel are registered in the channel corresponding list 41 so as to correspond to each other. As shown in FIG. 5, equipment identification (ID) numbers of the respective one-segment broadcasting tuners 221 to 22N and the channels and their frequencies respectively set to the one-segment broadcasting tuners 221 to 22N are registered in the tuner setting list 41.

The digital tuner control part 36 outputs the channel selection signal to the digital broadcasting tuner 27 on the basis of the retrieval result output from the channel retrieval part 37 to perform setting of the channel to be selected to the digital broadcasting tuner 27.

The one-segment tuner control part 35 refers to the tuner setting list 41 stored in the storage part 38 to perform setting of the channel to be selected to each of the one-segment broadcasting tuners 221 to 22N on the basis of the tuner setting list 41. The setting of the channel to the one-segment broadcasting tuners 221 to 22N is performed in every activation of the digital television broadcast receiving apparatus 11 or each time reception of the one-segment broadcasting is required and the one-segment tuner control part 35 is then driven. The one-segment tuner control part 35 can stop the channel selection operation by the one-segment broadcasting tuners 221 to 22N on the basis of stop instruction from the switching control part 34.

The switching control part 34 generates a switching signal to be supplied to the switching part 25. Further, the switching control part 34 generates a switching signal for switching the output of the switching part 25 on the basis of retrieval termination information and channel information output from the channel retrieval part 37, a processing termination signal output from the digital data processing part 28, tuner information output from the tuner setting list 41, and other information. Moreover, after the switching control part 34 outputs the switching signal, the switching control part 34 can output the stop instruction for stopping the channel selection operation by the one-segment broadcasting tuners 221 to 22N to the one-segment tuner control part 35.

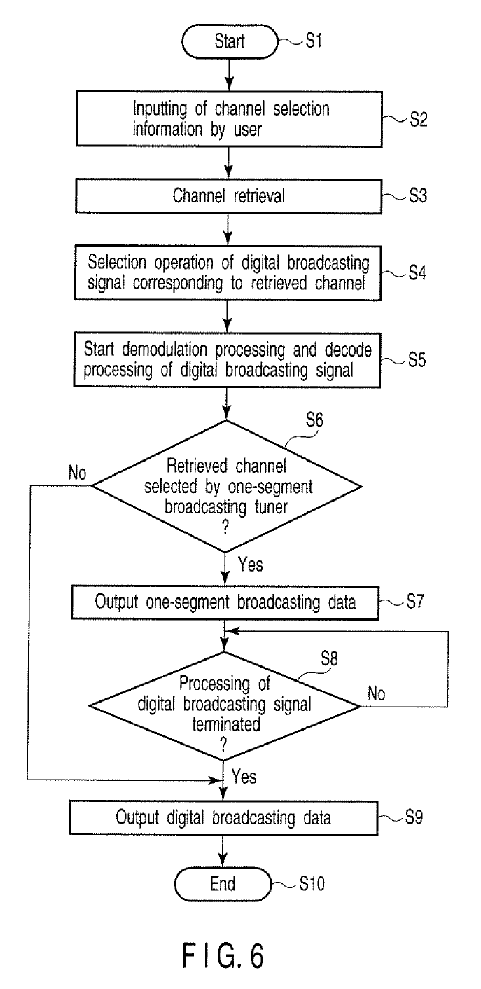

FIG. 6 shows a flowchart showing an example of a channel selection processing operation in the digital television broadcast receiving apparatus 11. Specifically, when the processing is started (step S1), channel selection information representing an intended broadcasting station is input from the operation input part 31 into the channel retrieval part 37 by a channel switching operation by a user (step S2). This channel switching operation is performed by inputting a channel number of the broadcasting station broadcasting a program that the user wants to view by operation of a numeric key or the like or by selecting a channel of the intended broadcasting station from a program list screen displayed on the flat display panel 14.

Then, the channel retrieval part 37 having received the channel selection information accesses the storage part 38 to retrieve the channel of digital broadcasting corresponding to the broadcasting station shown by the input channel selection information from the channel corresponding list 40 (step S3). When this retrieval is terminated, the channel retrieval part 37 outputs the retrieval result to the digital tuner control part 36 and the one-segment tuner control part 35, and at the same time, outputs the retrieval termination information to the switching control part 34.

Then, the digital tuner control part 36 having received the retrieval result from the channel retrieval part 37 outputs the channel selection signal to the digital broadcasting tuner 27 (step S4), whereby the digital broadcasting tuner 27 performs the channel selection operation of the digital broadcasting signal corresponding to the channel retrieved by the channel retrieval part 37.

The digital broadcasting tuner 27 selects the digital broadcasting signal of the designated channel to output the selected digital broadcasting signal to the digital data processing part 28. The digital data processing part 28 then starts various processings, such as the OFDM demodulation processing and the decode processing, to the digital broadcasting signal received from the digital broadcasting tuner 27 for the purpose of conversion into the digital broadcasting data realizing reproduction of video and audio (step S5).

As described, the switching control part 34 refers to the tuner setting list 41 stored in the storage part 38 in such a state that the processing by the digital data processing part 28 has been started, to obtain the tuner information of the one-segment broadcasting tuners 221 to 22N, that is, the channel information currently received by the one-segment broadcasting tuners 221 to 22N, and thus, to determine whether the channel information output from the channel retrieval part 37 is included in the obtained channel information (step S6).

If the answer in step S6 is “Yes”, the switching control part 34 receives the retrieval termination information from the channel retrieval part 37 to output a switching signal to the data selection part 32 of the switching part 25 (step S7). This switching signal controls the data selection part 32 such that, of the one-segment broadcasting data respectively output from the one-segment data processing parts 231 to 23N, the one-segment broadcasting data corresponding to the channel selected by the user in step S2 is selected and output. Thereby, before the processed digital broadcasting data is output from the digital data processing part 28, the one-segment broadcasting data of the same channel to which the processing has been applied is output to be used for viewing by users.

Thereafter, when the processing of the digital broadcasting data by the digital data processing part 28 is terminated, the processed digital broadcasting data is supplied to the data selection part 32. Meanwhile, when the processing of the digital broadcasting data is terminated, the digital data processing part 28 outputs the processing termination signal to the switching control part 34.

Therefore, the switching control part 34 determines whether the processing termination signal has been supplied from the digital data processing part 28 (step S8). If the answer is “Yes”, the switching control part 34 determines that the processing by the digital data processing part 28 is terminated, and controls the data selection part 32 such that the digital broadcasting data output from the digital data processing part 28 is selected and output (step S9), thereby terminating the processing (step S10).

Meanwhile, if the answer in step S6 is “No”, the switching control part 34 transfers to the processing in step S9 to control the data selection part 32 such that the digital broadcasting data output from the digital data processing part 28 is selected and output, and thus, to terminate the processing (step S10).

The flowchart shown in FIG. 6 shows the processing operation when the digital television broadcast receiving apparatus 11 does not have the same number of one-segment broadcasting tuners 221 to 22N as the number of all the channels of one-segment broadcasting. When the same number of one-segment broadcasting tuners 221 to 22N as the number of all the channels of one-segment broadcasting are provided in the digital television broadcast receiving apparatus 11, the determination processing in step S6 is omitted, and the processing is transferred from step S5 to step S7.

Specifically, when the user selects a channel through the operation input part 31, the switching control part 34 outputs the switching signal to the data selection part 32 of the switching part 25 such that, of the one-segment broadcasting data output from each of the one-segment data processing parts 231 to 23N, the one-segment broadcasting data corresponding to the channel selected by the user is selected and output. Thereafter, when the processing by the digital data processing part 28 is terminated, the data selection part 32 is controlled such that the digital broadcasting data is selected and output instead of the one-segment broadcasting data.

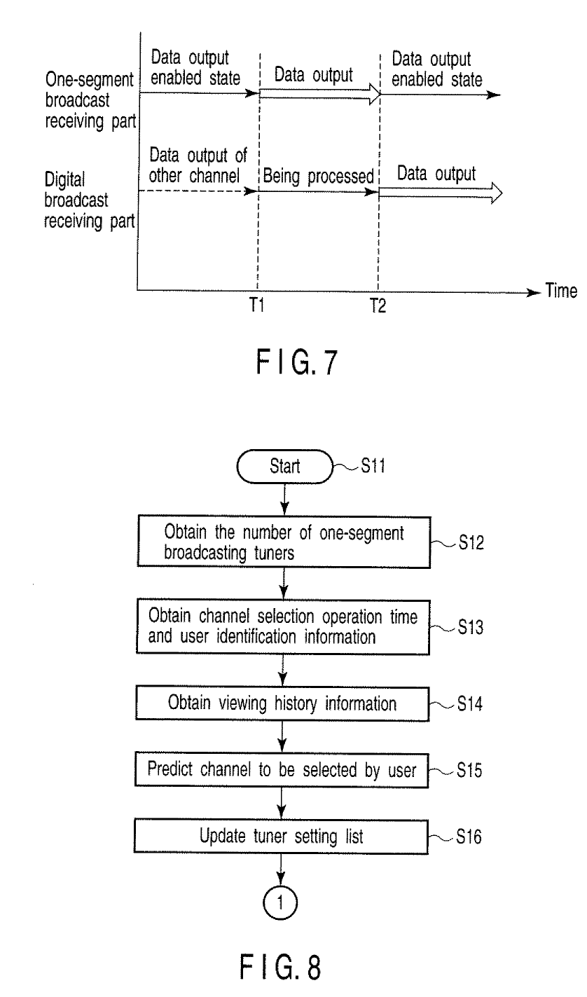

FIG. 7 shows a switching operation timing of the switching part 25. The output of the one-segment broadcast receiving part 20 and the output of the digital broadcast receiving part 27 are switched as mentioned above at the switching operation timing. In the one-segment broadcast receiving part 20, in a period prior to a time (selection operation time) T1 when the channel selection operation in the digital broadcast receiving part 27 is performed by the user, the one-segment broadcasting data has been output from the one-segment data processing parts 231 to 23N. Thus, the one-segment broadcasting data is capable of being output at any time whenever selected by the switching part 25. Meanwhile, in the digital broadcast receiving part 26, the digital data processing part 28 processes and outputs the digital broadcasting data of other channels, and this digital broadcasting data is selected by the switching part 25 to be used for viewing by users.

When the selection operation time T1 arrives, in the digital broadcast receiving part 26, the digital data processing part 28 starts the processing to the digital broadcasting signal of a newly selected channel. At this time, the switching part 25 is switched such that, of a plurality of the one-segment broadcasting data output from the one-segment broadcast receiving part 20, the one-segment broadcasting data corresponding to the newly selected channel is output, whereby on and after the selection operation time T1, the viewing based on the one-segment broadcasting data is performed instead of the digital broadcasting data.

Thereafter, when the processing by the digital data processing part 28 is terminated and a time (output switching time) T2 when the digital broadcasting data corresponding to the newly selected channel can be output arrives, the switching part 25 is switched so as to output the digital broadcasting data output from the digital data processing part 28, whereby, on and after the output switching time T2, the viewing based on the digital broadcasting data is performed instead of the one-segment broadcasting data.

Next, the viewing program prediction part 39 will be described. The viewing program prediction part 39 predicts a channel having a high possibility of being selected next from the channel currently viewed by a user to output channel update information as the prediction result to the tuner setting list 41 of the storage part 38. Thereby, the viewing program prediction part 39 can cause the one-segment broadcasting tuners 221 to 22N of the one-segment broadcast receiving part 20 to select beforehand the channel having a high possibility of being next selected by the user and cause the one-segment data processing parts 231 to 23N to perform the processing.

As channel prediction means in the viewing program prediction part 39, for example, there is the means for predicting a channel to be viewed according to the user's taste from among user identification information and time information input through the operation input part 31 and the history information accumulated in the history accumulation part 42 (see Jpn. Pat. Appln. KOKAI Publication No. 2006-254076). In addition, it is considered to predict a program of the next channel to be viewed on the basis of the operation for selecting a channel of a broadcasting station from a program listing screen displayed on the flat display panel 14, to predict the next channel to be viewed on the basis of the operation of a channel up/down key of the operation input part 31, to predict the next channel to be viewed on the basis of setting of a keyword or genre, and other means.

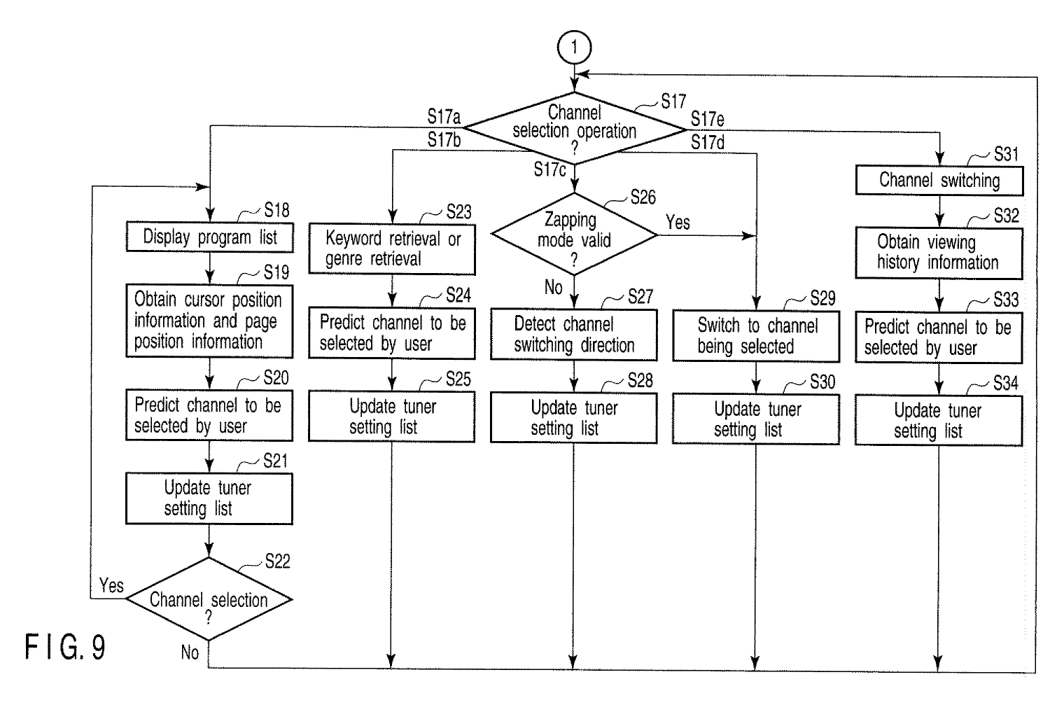

FIGS. 8 and 9 are flowcharts each showing an example of the processing operation in which the viewing program prediction part 39 updates the tuner setting list 41. Specifically, when the processing for updating the tuner setting list 41 is started (step S11), the viewing program prediction part 39 obtains the number of the one-segment broadcasting tuners 221 to 22N connected to the digital television broadcast receiving apparatus 11 (step S12).

Next, the viewing program prediction part 39 obtains the time when the channel selection operation is performed and the input user identification information (step S13) to obtain the past viewing history information of the user from the history accumulation part 42 (step S14). Then, the viewing program prediction part 39 researches the user's taste on the basis of the viewing history information to predict the next channel to be selected by the user (step S15).

Thereafter, for example on the basis of the viewing history information obtained from the history accumulation part 42, the viewing program prediction part 39 sets a priority level in order of the channel having a high possibility of being selected by a user at the time when the channel selection operation is performed, to thereby update the tuner setting list 41 in accordance with the set channel order (step S16).

The user identification information can be input not only by key operation in the operation input part 31 but also by using an image recognition sensor, a fingerprint authentication sensor, or the like which is mounted in the operation input part 31 or the flat display panel 14. Alternatively, the user identification information can be directly input by the touching operation of a screen for user identification displayed on the flat display panel 14. In addition, face image information of a user taken by a mobile device is transmitted to the digital television broadcast receiving apparatus 11 through transmission means such as infrared ray, internet, Bluetooth (registered trademark), or the like, and the digital television broadcast receiving apparatus 11 then analyzes the face image information, whereby the user can be identified.

Next, in step S17, a user performs the channel selection operation for selecting an intended channel of a broadcasting station. The channel selection operation is performed by inputting the channel number of the broadcasting station broadcasting a program that the user wants to view by the key operation of the operation input part 31, by selecting the intended channel of a broadcasting station from the program listing screen displayed on the flat display panel 14, or by other means. A method for updating the tuner setting list 41 is different among each selection operation. Therefore, the tuner setting list 41 stores a parameter representing the selection operation method having been used for updating the tuner setting list 41.

When the intended channel of a broadcasting station is selected from the program listing screen displayed on the flat display panel 14 (step S17a), the program listing screen is displayed on the flat display panel 14 (step S18), and then information showing a position on the program listing screen where a cursor is placed, page information of a program list, and other information are obtained (step S19). In step S20, channels having a high possibility of being selected by a user are predicted based on the position information of the cursor and the page information of the program list which have been obtained in step S19, and a priority level is then given to each predicted channel. Thereafter, in step S21, the tuner setting list 41 is updated based on the priority level information. In step S22, the presence of the channel selection is determined, if the answer is “Yes”, the processing is returned to step S18, while if the answer is “No”, the processing is returned to step S17.

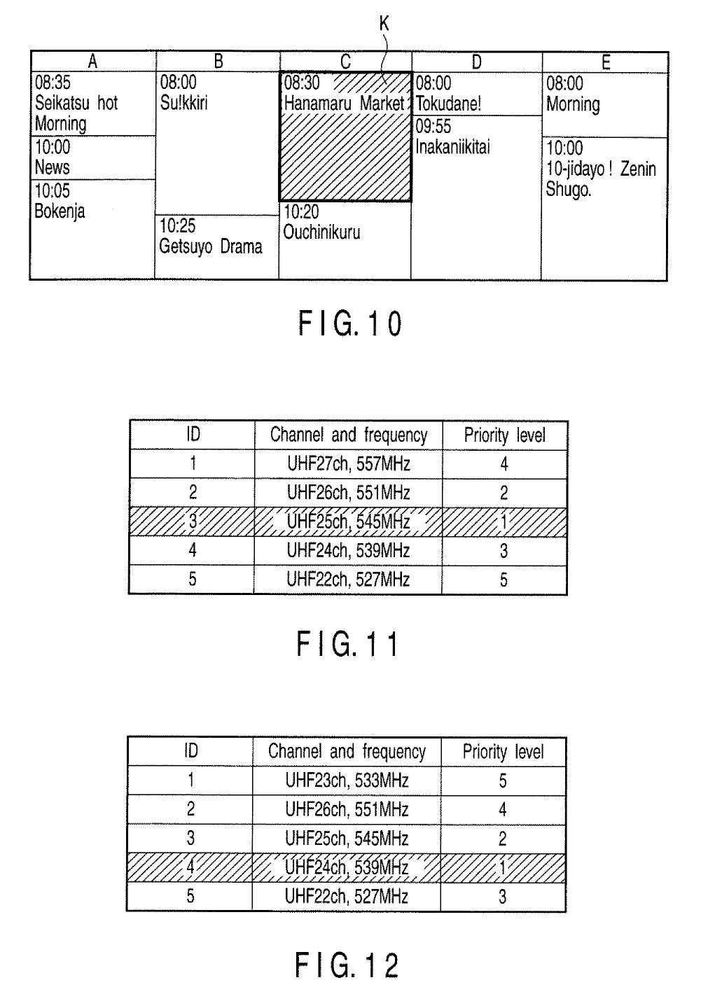

FIG. 10 shows an example of the program listing screen displayed on the flat display panel 14. If a cursor K (shown by hatching) is matched to a program of a C station at the present moment, the channel (C station) to which the cursor K is matched has the highest priority level, the channels (B station, D station) at the both sides of the C station have the second highest priority level, and the channels (A station, E station) at the both ends of the program listing screen have the third highest priority level. Specifically, a channel displayed at a closer position to the channel to which the cursor K is matched has a higher priority level, while a channel displayed at a farther position from the channel to which the cursor K is matched has a lower priority level. The viewing program prediction part 39 updates the tuner setting list 41 on the basis of the priority level information determined as described above.

When a keyword key or genre key provided in the operation input part 31 is operated to select the intended channel of a broadcasting station (step S17b), a program corresponding to the keyword or genre is retrieved from an electronic program list (step S23). In step S24, channels having a high possibility of being selected by the user are predicted from the retrieved channels, and the priority level is given to each predicted channel. In step S25, the tuner setting list 41 is updated based on the priority level information, and the processing is then returned to step S17.

In that case, when there are a plurality of retrieval results, the viewing history information of the user is obtained from the history accumulation part 42, and the priority level is then given to the retrieval results on the basis of the viewing history information, whereby the tuner setting list 41 can be updated based on the priority level information. Incidentally, the keywords or genre can be input through the menu screen displayed on the flat display panel 14 or through other means. Further, the keyword or genre capable of being set may be arbitrarily input by a user.

When the channel up/down key provided in the operation input part 31 is operated to select the intended channel of a broadcasting station (step S17c), it is determined whether a zapping mode is valid in step S26. When the zapping mode is invalid (S26: No), it is detected whether the channel is switched in the up direction or the down direction (step S27). In step S28, the tuner setting list 41 is updated based on the detection result, and the processing is returned to step S17. Incidentally, the zapping mode is set through the menu screen displayed on the flat display panel 14 or set by operation of a zapping mode setting key provided in the operation input part 31.

FIGS. 11 and 12 show an example of the update of the tuner setting list 41 performed when the channel is switched by using the channel up/down key. In FIGS. 11 and 12, there are five one-segment broadcasting tuners 221 to 22N. In FIG. 11, the channel information is stored such that the channels and the frequencies are aligned in descending or ascending order at the time when the channel up/down key of the operation input part 31 is operated.

In the above state, as shown in FIG. 12, when the channel up/down key is operated, the tuner setting list 41 is updated such that the priority level is equally allocated in a channel up direction and a channel down direction with reference to the channel being currently viewed. For instance, in such a state that a 25 channel is selected as shown by hatching in FIG. 11, when the channel down key is operated and a 24 channel is selected as shown by hatching in FIG. 12, update information is output from the viewing program prediction part 39 to the tuner setting list 41 such that a channel (27 channel) in the channel up direction opposite to this channel switching direction is deleted from the list, while a new channel (23 channel) in the channel down direction is added in the tuner setting list 41. The tuner setting list 41 is updated based on the update information.

When an intended channel of a broadcasting station is selected by operation of a zapping button provided in the operation input part 31 (S17d), or when the zapping mode is valid in step S26 (S26: Yes), the switching to a channel having the highest priority level in the tuner setting list 41, that is, a channel which has been already selected by the one-segment broadcasting tuners is performed (step S29). A method having been used for updating the tuner setting list 41 prior to this channel switching is confirmed, and the tuner setting list 41 is updated by the same method as the previous updating method (step S30). In the processing in step S29, since the channel having the highest priority is selected, a channel which has not been selected in the previous setting is newly set in the tuner setting list 41. At the same time, the channel prior to the switching to the selected channel may be added in the tuner setting list 41.

When the intended channel of a broadcasting station is selected by operation of a channel key provided in the operation input part 31 (S17e), a channel corresponding to the operated channel key is selected in step S31. In step S32, the past viewing history information of a user is obtained from the history accumulation part 42 on the basis of the time when the channel selection operation is performed and the user identification information. In step S33, the user's taste is researched based on the information obtained from the history accumulation part 42, and then the next channel to be selected by the user is predicted. Thereafter, in step S34, by way of example, the priority level is set in order of channel having a high possibility of being selected by the user at time when the channel selection operation is performed based on the viewing history information obtained from the history accumulation part 42, and then the tuner setting list 41 is updated in accordance with the set channel order. Thereafter, the processing is returned to step S17.

A series of processing operation shown in FIGS. 8 and 9 can be started when the input operation part 31 is operated or when the digital television broadcast receiving apparatus 11 is activated. Additionally, a sensor for detecting that a person approaches the apparatus is mounted in the operation input part 31, the flat display panel 14, or the like, whereby the prediction operation can be started based on a signal output from this sensor.

Further, it is possible to mount a function to notify a user of a channel selected by the one-segment broadcast receiving part 20 after the tuner setting list 42 has been updated based on the above prediction processing of the channel. For instance, a light-emitting diode (LED) is embedded in the channel key provided in the operation input part 31, whereby it is possible to realize light emission of the LED of the key corresponding to the selected channel, or to display the selected channel on the flat display panel 14.

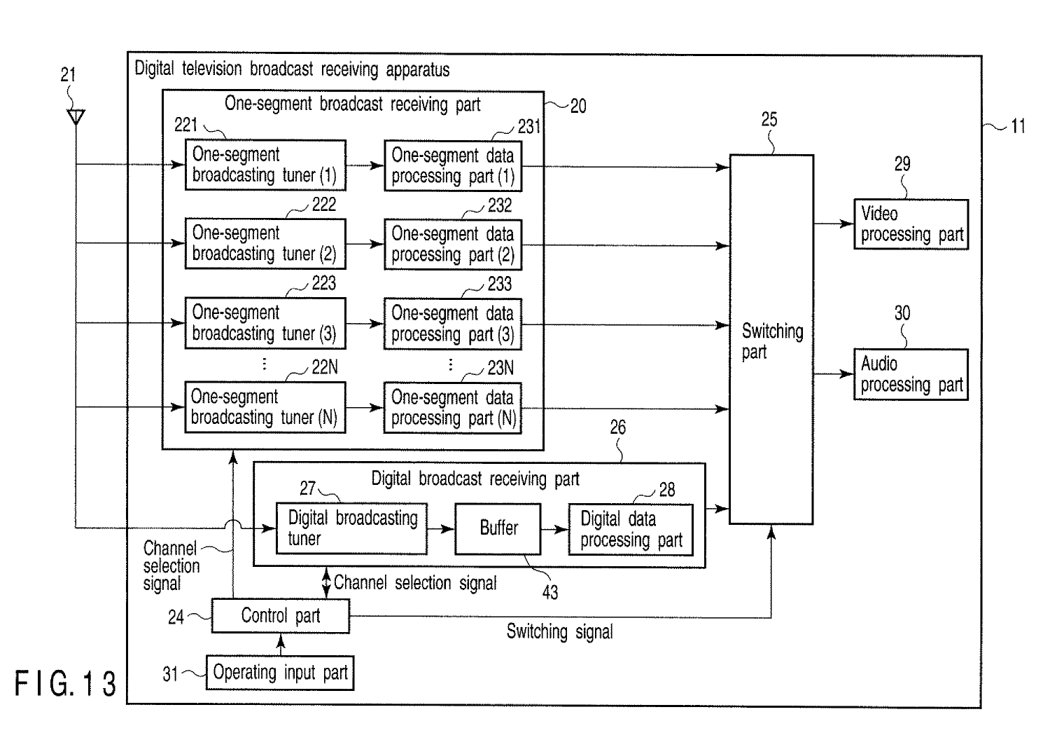

FIG. 13 shows a modified example of the digital television broadcast receiving apparatus 11. In FIG. 13, the same components as those in FIG. 2 are assigned the same reference numerals. The digital broadcast receiving part 26 includes a buffer 43 as delay means connected between the digital broadcasting tuner 27 and the digital data processing part 28. The buffer 43 is composed of, for example, a storage device such as a memory and a register.

Accordingly, the time required for demodulation processing and decode processing of the one-segment broadcasting signal is longer than the time required for the demodulation processing and the decode processing of the digital broadcasting signal. Therefore, when the demodulation processing and the decode processing are applied to the one-segment broadcasting signal and the digital broadcasting signal at the same time, a video image of one-segment broadcasting is displayed later than that of digital broadcasting. Specifically, immediately after the demodulation processing and the decode processing to the digital broadcasting signal are terminated and the digital television broadcast receiving apparatus 11 is in the state of capable of displaying a video image, the output of the one-segment broadcasting is switched to the output of the digital broadcasting, whereby the broadcasting content later than the content of one-segment broadcasting is displayed. Namely, the output is switched, whereby the content is skipped to be discontinuous.

Therefore, as shown in FIG. 13, the buffer 43 is connected behind the digital broadcasting tuner 27 to delay the digital broadcasting signal, and thus to synchronize the digital broadcasting with the one-segment broadcasting, whereby the video images can be smoothly connected to each other when the switching from the one-segment broadcasting to the digital broadcasting is performed. Thus, the buffer 43 sets that the digital broadcasting signal is delayed by a time obtained by subtracting the time required for the processing of the digital broadcasting signal from the time required for the processing of the one-segment broadcasting signal.

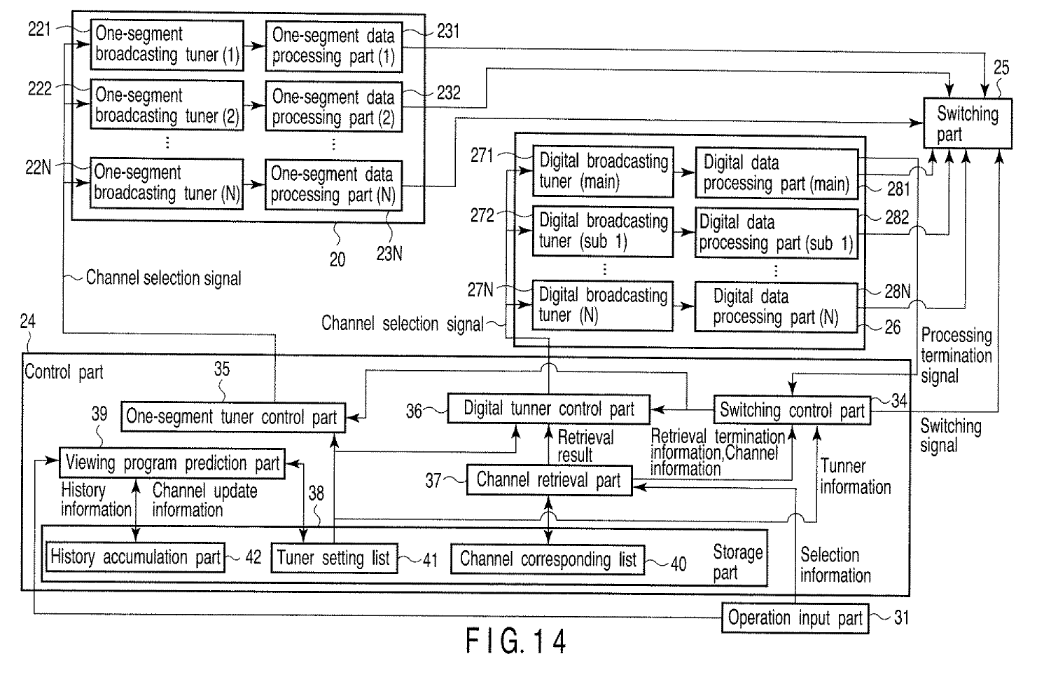

FIG. 14 shows another modified example of the digital television broadcast receiving apparatus 11. In FIG. 14, the same components as those in FIG. 4 are assigned the same reference numerals. The digital broadcast receiving part 26 is provided with a plurality of (N) tuners 271, 272, . . . , 27N for digital broadcasting and digital data processing parts 281, 282, . . . , 28N connected corresponding to the digital broadcasting tuners 271 to 27N.

In this case, the tuner setting list 41 is updated such that channels having a high priority level are allocated in the digital broadcasting tuners 271 to 27N. In addition, parameters representing that channels including for both the one-segment broadcasting and the digital broadcasting are allocated in which of the tuners 221 to 22N and 271 to 27N are stored in the tuner setting list 41.

In the above constitution, the one-segment broadcasting tuners 221 to 22N and the digital broadcasting tuners 271 to 27N are mixed; however, all the tuners may be the digital broadcasting tuners 271 to 27N.

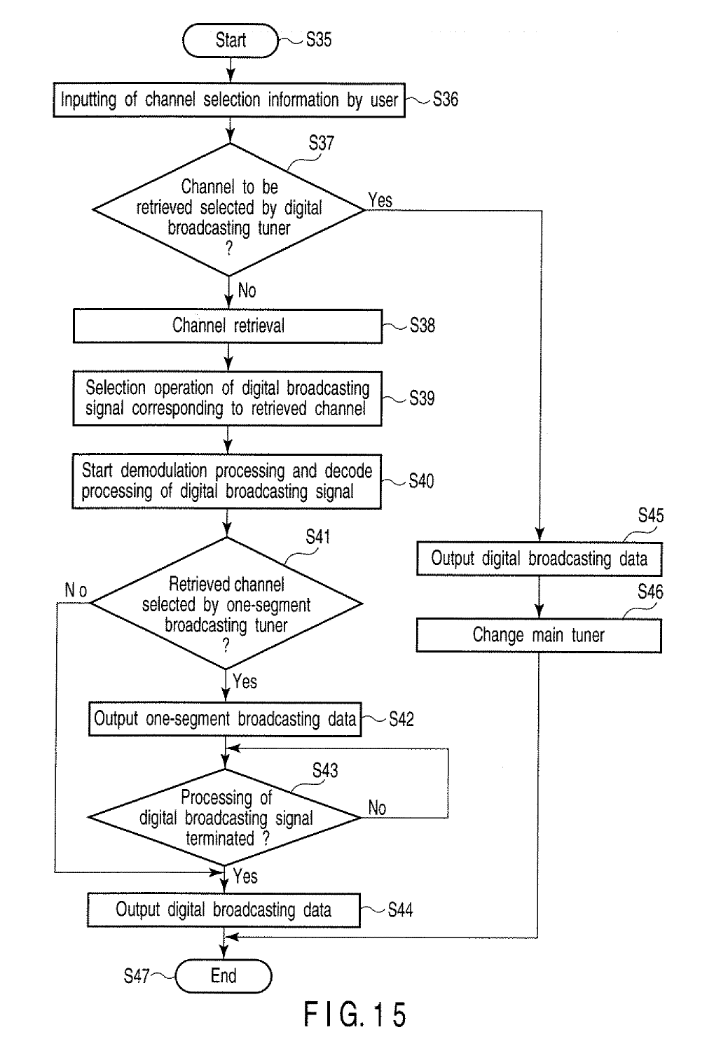

FIG. 15 shows a flowchart showing an example of the channel selection processing operation in the case where the plural one-segment broadcasting tuners 221 to 22N and the plural digital broadcasting tuners 271 to 27N are mixed. Specifically, when the processing is started (step S35), the channel selection information showing an intended broadcasting station is input from the operation input part 31 to the channel retrieval part 37 by the channel switching operation performed by a user (step S36). This channel switching operation is performed by inputting a channel number of a broadcasting station broadcasting a program that the user wants to view by the operation with a numeric key or the like, or by selecting a channel of the intended broadcasting station from a program listing screen displayed on the flat display panel 14.

Thereafter, in step S37, the switching control part 34 refers to the tuner setting list 41 stored in the storage part 38 to obtain tuner information of the digital broadcasting tuners 271 to 27N, that is, channel information currently received by the digital broadcasting tuners 271 to 27N, and thus, to determine whether the channel information output from the channel retrieval part 37 is included in the obtained channel information.

If the answer in step 37 is “No”, the channel retrieval part 37 having received the channel selection information accesses the storage part 38 (step S38) to retrieve, from the channel corresponding list 40, the channel of digital broadcasting corresponding to the broadcasting station shown by the input channel selection information. When this retrieval is terminated, the channel retrieval part 37 outputs the retrieval result to the digital tuner control part 36 and the one-segment tuner control part 35, and at the same time, outputs the retrieval termination information to the switching control part 34.

Thereafter, the digital tuner control part 36 having received the retrieval result from the channel retrieval part 37 outputs the channel selection signal to the digital broadcasting tuner 271 provisionally set as a main tuner (step S39). Thereby, the digital broadcasting tuner 271 performs the selection operation of the digital broadcasting signal corresponding to the channel retrieved by the channel retrieval part 37.

The digital broadcasting tuner 271 selects the digital broadcasting signal of the designated channel to output the selected digital broadcasting signal to the digital data processing part 281. Thereby, in step S40, the digital data processing part 281 starts various processings such as the OFDM demodulation processing and the decode processing for converting the digital broadcasting signal received from the digital broadcasting tuner 271 into digital broadcasting data reproducible as video and audio.

As described, in step S41, the switching control part 34 refers to the tuner setting list 41 stored in the storage part 38, in such a state that the processing by the digital data processing part 281 is started, obtains the tuner information of the one-segment broadcasting tuners 221 to 22N, that is, the channel information currently received by the one-segment broadcasting tuners 221 to 22N, and determines whether the channel information output from the channel retrieval part 37 is included in the obtained channel information.

If the answer in step S41 is “Yes”, the switching control part 34 receives the retrieval termination information from the channel retrieval part 37 to output the switching signal to the data selection part 32 of the switching part 25 (step S42). This switching signal controls the data selection part 32 such that, of the one-segment broadcasting data respectively output from the one-segment data processing parts 231 to 23N, the one-segment broadcasting data corresponding to the channel selected by the user in step S36 is selected and output. Thereby, before the processed digital broadcasting data is output from the digital data processing part 281, the one-segment broadcasting data of the same channel to which the processing has been applied is output to be used for viewing by users.

Thereafter, when the processing of the digital broadcasting data by the digital data processing part 281 is terminated, the processed digital broadcasting data is supplied to the data selection part 32. Meanwhile, when the processing of the digital broadcasting data is terminated, the digital data processing part 281 outputs the processing termination signal to the switching control part 34.

Therefore, the switching control part 34 determines whether the processing termination signal has been supplied from the digital data processing part 281 (step S43). If the answer is “Yes”, the switching control part 34 determines that the processing by the digital data processing part 281 is terminated, and controls the data selection part 32 such that the digital broadcasting data output from the digital data processing part 281 is selected and output (step S44), thereby terminating the processing (step S47).

Meanwhile, if the answer in step S41 is “No”, the switching control part 34 transfers to the processing in step S44 to control the data selection part 32 such that the digital broadcasting data output from the digital data processing part 281 is selected and output, thereby terminating the processing (step S47).

Further, if the answer in step S37 is “Yes”, the switching control part 34 controls the data selection part 32 such that, of the digital broadcasting signals respectively output from the digital data processing parts 281 to 28N, the digital broadcasting data corresponding to the channel having been selected by the user in step S36 is selected and output (step S45). Thereafter, in step 46, the main tuner is changed, and then the processing is terminated (step S47).

Here, each processing performed by the control part 24 and the switching part 25 can be performed by software, using a plurality of central processing units (CPUs). Additionally, each processing performed by the one-segment data processing parts 231 to 23N and the digital data processing parts 281 to 28N also can be performed by the software, using the plurality of CPUs. In this configuration, the broadcasting signals obtained from the respective tuners 221 to 22N, 27 and 271 to 27N are processed in time division, whereby hardware resources can be saved.

Further, although the digital broadcasting tuners 27 and 271 to 27N and the one-segment broadcasting tuners 221 to 22N are built in the digital television broadcast receiving apparatus 11, these tuners may be connected through internet or various communication cables as an external device.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A broadcast receiving apparatus comprising:
a plurality of first tuners each configured to select a broadcasting signal of a channel based on a tuner setting list, from a received one-segment broadcasting signal;
a second tuner configured to select a broadcasting signal of a predetermined channel from digital broadcasting using a plurality of segments; and
a control part configured to select and output the one-segment broadcasting signal when the second tuner is switched from one channel to another.

2. The broadcast receiving apparatus according to claim 1, wherein the control part selects an output of the first tuners that select the one-segment broadcasting signal corresponding to a channel to which the second tuner is switched, and keeps producing the selected output for a predetermined time in place of an output of the second tuner.

3. The broadcast receiving apparatus according to claim 2, wherein the control part is configured to output a signal selected by the second tuner and subjected to the demodulation processing and the decode processing after elapse of the predetermined time.

4. The broadcast receiving apparatus according to claim 1, further comprising:
a delay part configured to delay the broadcasting signal which is selected by the second tuner and for which the demodulation processing and the decode processing have been performed, such that the broadcasting signal is synchronized with the broadcasting the signal which is selected by the first tuners and for which the demodulation processing and decode processing have been performed.

5. The broadcast receiving apparatus according to claim 1, further comprising:
an accumulation part configured to accumulate viewing history information; and
an update part configured to predict a channel having a high possibility of being selected next on the basis of the viewing history information accumulated in the accumulation part, and to update the tuner setting list such that the predicted channel is selected.

6. The broadcast receiving apparatus according to claim 5, wherein the update part determines a priority level in order of channel having a high possibility of being selected next and updates the tuner setting list such that channels are selected in descending order of the priority level.

7. The broadcast receiving apparatus according to claim 6, wherein when a channel selection operation for selecting a channel from a displayed program listing screen is performed, the update part updates the tuner setting list such that a channel displayed adjacent to the selected channel has the highest priority level and a channel displayed farther from the selected channel has a lower priority level on the program listing screen.

8. The broadcast receiving apparatus according to claim 6, wherein when the channel selection operation is performed by a channel up/down key, the update part updates the tuner setting list such that a high priority level is given to a channel existing immediately before or immediately after the selected channel in order of channels selected by the channel up/down key and a lower priority level is given to a channel farther from the selected channel.

9. A broadcast receiving apparatus according to claim 8, wherein when the channel selection operation is performed by use of the channel up/down key, the update part updates the tuner setting list such that a channel existing in a direction opposite to a channel switching direction is deleted from the tuner setting list and a channel existing in the channel switching direction is added to the tuner setting list.

10. A broadcast receiving apparatus according to claim 5, wherein when the channel selection operation is performed by designating a keyword or genre, the update part updates the tuner setting list such that, of channels corresponding to the designated keyword or genre, the priority level is set in order of channel having a high possibility of being selected and a channel is selected in descending order of the priority level.

11. The broadcast receiving apparatus according to claim 1, further comprising:
a display part configured to display a channel selected by the first tuners on the basis of the tuner setting list.

12. A broadcast receiving method comprising:
causing a plurality of first tuners to select a broadcasting signal of a predetermined channel from received one-segment broadcasting on the basis of a tuner setting list set in advance;
causing a second tuner to select a broadcasting signal of a predetermined channel from digital broadcasting using a plurality of received segments;
detecting when the second tuner is switched from one channel to another, selecting a one-segment broadcasting signal.

13. The broadcast receiving method according to claim 12, wherein the selecting selects an output of the first tuners that select the one-segment broadcasting signal corresponding to a channel to which the second tuner is switched, and keeps producing the selected output for a predetermined time in place of an output of the second tuner.

14. The broadcast receiving method according to claim 13, wherein a signal which is selected by the second tuner and for which demodulation processing and decode processing have been performed is output after elapse of the predetermined period of time.
